(19) United States
(12) Patent Application Publication
(10) Pub. No.: US 2026/0187132 A1
(43) Pub. Date: Jul. 2, 2026

(54) MULTI-CHANNEL CONTACT REASON EXTRACTION AND TOPIC GENERATION

(71) Applicant: Salesforce, Inc., San Francisco, CA (US)

(72) Inventors: Wei Ling Katherine Tan, Bellevue, WA (US); Rishika Verma, San Francisco, CA (US); Regunathan Radhakrishnan, San Francisco, CA (US); Nachiketa Mishra, San Francisco, CA (US); Sitaram Asur, San Francisco, CA (US)

(21) Appl. No.: 19/042,449

(22) Filed: Jan. 31, 2025

Related U.S. Application Data
(60) Provisional application No. 63/741,235, filed on Jan. 2, 2025.
(60) Provisional application No. 63/741,246, filed on Jan. 2, 2025.

(51) Int. Cl. G06F 16/34; G06F 16/335

(52) U.S. Cl. CPC G06F 16/345; G06F 16/335

(57) ABSTRACT

A customer relationship management (CRM) system can leverage a generative machine learned model to extract customer insights from conversation data. In some examples, the generative machine learned model may be a large language model (LLM) that is trained to extract customer contact reasons from data associated with different communication channel types. The system may generate input data to input into the LLM. When generating the input data, the system can identify non-essential conversation data associated with the different communication channel types. Responsive to a prompt, the LLM may disregard the non-essential conversation data and extract a primary contact reason consistently across the different communication channels.

### RELATED APPLICATIONS

This application claims priority to U.S. Provisional Patent Application No. 63/741,235, entitled “Multi-Channel Contact Reason Extraction and Topic Generation,” filed Jan. 2, 2025 and U.S. Provisional Patent Application No. 63/741,246 entitled “Most Informative Utterances in Multi-Channel Contact Reason Extraction,” filed Jan. 2, 2025. The above-identified applications are herein incorporated by reference in their entirety.

### TECHNICAL FIELD

Many organizations now operate within a multi-channel customer service landscape. Multi-channel customer service involves engaging and interacting with customers through multiple communication channels to create and maintain a consistent customer experience. Such communication channels may include both online and offline communication channels such as messaging platforms, email, web forms, voice calls, social media sites and the like. Thus, multi-channel customer service paradigms aim to meet and engage customers “where they are,” and thereby facilitate convenient and personalized customer experiences no matter the particular communication channel a customer uses. However, extracting actionable customer insights within a multi-channel customer service environment presents significant technical challenges related to one or more of channel diversity, inconsistency of contextual clues, noise and/or ambiguity, cross-channel integration, and limitations of rule-based natural language processing (NLP) approaches. Thus, it is necessary to provide techniques that facilitate a seamless, interconnected experience across all channels.

### BRIEF DESCRIPTION OF THE DRAWINGS

The detailed description is described with reference to the accompanying figures. In the figures, the left-most digit of a reference number identifies the figure in which the reference number first appears. The use of the same reference numbers in different figures indicates similar or identical components or features. The figures are not drawn to scale.

FIG. 1 illustrates an example environment for performing techniques described herein.

FIG. 2 depicts a block diagram illustrating the interactions of components of a normalized issue extraction and normalization component configured to extract primary customer contact reasons from conversation data associated with different communication channel types.

FIG. 3 illustrates a pictorial flow diagram with an example process for disregarding non-essential conversation data and/or clustering similar sentences.

FIG. 4 is a flow diagram illustrating an example process of receiving a request for a generative machine learned model to perform an action, generating input data to input to the generative machine learned model, and outputting a response based on inputting the input data to the generative machine learned model.

FIG. 5 illustrates an example user interface associated with a CRM environment as described herein, and comprising a data feed.

### DETAILED DESCRIPTION

A customer relation management (CRM) system can leverage a generative machine learning model (such as, for example, a large language model (LLM)) to extract valuable customer insights from diverse communication channels (or “channels”). A communication channel can be a data route used for exchanging data between customers and an organization (e.g., via the CRM system). For example, a communication channel may be established between and among various computing devices, allowing the computing devices to communicate and share data between and among each other over one or more networks. In some cases, communication channels may differ from each other in one or more ways. For instance, different communication channels may be managed and/or monitored by different teams. Thus, in some cases, different communication channels may implement different management, engagement and/or or marketing strategies. Even still, different customers may have different preferences and/or tendencies regarding which communication channels they use and/or how particular communication channels are used. Therefore, each communication channel can have a unique structure and/or format as appropriate. Extracting actionable intent from these diverse communication channels is essential for delivering consistent and effective support, but this task presents several significant technical challenges.

In some examples, the CRM system described herein can be a channel-based system leveraging various diverse communication channel types for facilitating communication between customers and organization(s). For example, in order to facilitate quick interactions and feedback, the CRM system may leverage messaging platforms configured to allow shorter, more fragmented conversations. In some examples, such as to facilitate official announcements and updates for instance, the CRM system may additionally or alternatively leverage email, which is configured for more formal and structured text. In still some other cases, the CRM system may leverage web forms that can include predefined fields and free text to facilitate communication between customers and an organization. Further still, the CRM system may leverage voice calls to allow for unstructured conversational exchange between customers and organization(s). It will be understood that the preceding examples are not limiting, and that other and/or more communication modalities are contemplated herein.

In various implementations, the models and/or modules described herein may be classification, predictive, generative, conversational, or another form of artificial intelligence (AI) technology, such as AI model(s), agents, etc., implementing one or more forms of machine learning, a neural network, statistical modeling, deep learning, automation, natural language processing, or other similar technology. The AI technology may be included as part of a network or system comprising a hardware-or software-based framework for training, processing, fine-tuning, or performing any other implementation steps. Furthermore, the AI technology may include a hardware-or software-based framework that performs one or more functions, such as retrieving, generating, accessing, transmitting, etc. The AI technology may be implemented by a computer including a register coupled with a processor or a central processing unit (CPU), graphics processing unit (GPU) or the like.

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally or alternatively, the AI technology may be intermittently updated at a set interval or in real time based on resulting output or additional data to further train the AI technology. The AI technology may offer a variety of capabilities including text, audio, image, and other content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement Retrieval-Augmented Generation (RAG) or other techniques after training or fine-tuning by accessing a set of documents or knowledge base directed to a particular field or website other than the training or fine-tuning data to influence the AI technology's output with the set of documents or knowledge base.

To further guide and train output of the AI technology, a plurality of input prompts may be provided to the AI technology for the purpose of eliciting particular responses. In various implementations, the plurality of input prompts may correspond to the particular field or task to which the AI technology is trained. Additionally, the AI technology may be implemented along with a plurality of additional AI technologies. For example, a first AI model may produce a first output, which is used as input for a second AI model to produce a second output. These AI technologies may be used in succession of one another, in parallel with another, or a combination of both. Furthermore, the AI technologies may be merged in a variety of implementations, for example, by bagging, boosting, stacking, etc. the AI technologies.

In some examples, data associated with communication channels can be extracted and/or presented as a common conversation object by the CRM system and/or for consumption by the CRM system. In some examples, the common conversation object can be leveraged to generate an LLM prompt. In some examples, based on the LLM prompt, the CRM system can determine customer contact reasons associated with the communication channels. In some examples, data associated with the customer contact reasons can be presented via a user interface for downstream use. For instance, the user interface can comprise a data feed wherein customer contact reasons are clustered according to topic and/or similarity of topic. On the other hand, for example, traditional CRM methods often require users to determine customer contact reasons by running reports separately for each different communication channel that is used. In other words, traditional CRM methods increase computational overhead while not affording users an efficient, consolidated view of their top customer contact reasons across multiple diverse communication channels. The techniques described herein thus overcome the technical challenges associated with extracting customer contact reasons from heterogenous communication channels.

Unlike traditional CRM methods, wherein different extraction methods are required based on a communication channel type, the techniques described herein allow for use of a common extractor across communication channels. Thus, the techniques discussed herein may comprise generating, based on conversation data received via one or more communication channels of the CRM system, a common conversation object. For instance, the CRM system of various examples may receive and/or process various types of conversation data (e.g., raw data representative of a conversation). In some instances, the CRM system may receive audio data comprising a conversation via a voice call communication channel. The CRM system may, in some instances, receive video data comprising a conversation via a social media communication platform or the like. For instance, the CRM system may parse the video data to generate a textual transcript of the video data, on which a common conversation object may be based. In some cases, conversation data may comprise text data (e.g., keystroke, mouse click, or AASCII data underlying what is perceived as text) received via a communication channel. The CRM system of various examples may parse or otherwise process such conversation data to generate an accurate transcript of the conversation. Thus, a common conversation object of various examples may comprise a transcript that is representative of the underlying conversation data and facilitates extraction of actionable customer intent without respect to a type of communication channel. For instance, a common conversation object of various examples facilitates (e.g., voice call versus email). In some cases, a common conversation object is represented in a Javascript Object Notation (JSON) format.

In some examples, the CRM system may generate the common conversation object by retrieving data from one or more sources. Such sources may include one or more databases within or otherwise associated with the CRM system. Accordingly, the CRM system may incorporate data from various sources when generating the common conversation object. In some examples, generating the common conversation object can comprise parsing raw data (e.g., data that is received or ingested directly from a providing instrument) that is received or accessed by the CRM system. For instance, the CRM system of various examples may be configured to receive (e.g., via one or more communication channels of the CRM system) or otherwise access raw data associated with customer service calls.

Taking a use case involving a banking call center as an illustrative but non-limiting example, generating one or more common conversation objects may comprise transcribing audio files that capture phone calls between call center agents and customers. Accordingly, the raw audio data may be converted to text data, and the resulting text data may be processed in order to generate the common conversation object(s). In some instances, processing text data to generate a common conversation object comprises “cleaning” the text by removing unnecessary/irrelevant characters, words, phrases, sounds/phonemes, pauses, punctuation, or other data that is not pertinent to the purpose of the conversation. In the case of our example involving phone calls between call center agents and customers, such unnecessary words may include greetings, pleasantries, stop words, repetitive utterances, and/or filler words (“a,” “the,” “huh,” “umm,” or the like), conversation indicative of and/or exclusive to a particular communication channel type, etc. In some instances, processing text data to generate a common conversation object comprises generating speaker labels which identify who is speaking at each point in the conversation. Accordingly, in some instances, processing text data to generate a common conversation object further comprises generating, normalizing, or otherwise validating timestamps that associate each piece of text with a time at which it was spoken. The CRM system may generate, from the example phone call discussed above, the following example common conversation object, substantially in the form of a JSON object including speaker labels and timestamps as provided below:

```
{
    “speaker _labels”: {
          “speaker1”: “AGENT”,
          “speaker2”: “CUSTOMER”
  },
“transcript”: [
      {
        “text”: “Thank you for calling. This is <AGENT_NAME>. May I
        please have the full name
              and email associated with your account?”,
        “speaker”: “AGENT”,
      “timestamp”: “00:00:05”
      },
      {
      “text”: “My name's <CUSTOMER_NAME>.”,
      “speaker”: “CUSTOMER”,
      “timestamp”: “00:00:10”
      },
    {
    “text”: “Okay. Can you just confirm the email of birth and the
    last four of your social please?”,
    “speaker”: “AGENT”,
    “timestamp”: “00:00:15”
    },
  {
    “text”: “Okay. <CUSTOMER_EMAIL>. Um um, <CUSTOMER_SSN>, and my birthday is
            <CUSTOMER BIRTHDAY>.”,
    “speaker”: “CUSTOMER”,
    “timestamp”: “00:00:20”
    },
  {
    “text”: “Okay. How can I help you out?”,
    “speaker”: “AGENT”,
  “timestamp”: “00:00:23”,
  },
  {
  “text”: “I I worked Thursday. Per facility and Jay and they still haven't paid me.”,
      “speaker”: “CUSTOMER”,
      “timestamp”: “00:00:31”,
    },
  {
    “text”: “Okay, let me take a look at me Just a moment. So Thursday being
    let me see the 25^{th}.”,
      “speaker”: “AGENT”,
      “timestamp”: “00:00:40”,
    },
  {
  “text”: “Yeah.”,
      “speaker”: “CUSTOMER”,
      “timestamp”: “00:00:41”,
  },
  {
  “text”: “Okay, just a moment. Okay, so it looks like they have not, um, resolve that invoice yet
            So since it's past the 48 hours, I'm gonna go ahead and escalate this for you.”,
  “speaker”: “AGENT”,
  “timestamp”: “00:00:51”
  }
  ]
}
```

By generating one or more common conversation objects, the CRM system of various examples may parse raw conversation data from heterogeneous communication channels into a common format to be leveraged by one or more LLM(s) in performing tasks. For instance, a first common conversation object generated based on conversation data received via a voice call communication channel—such as in the above example, can be formatted similarly to or the same as a second common conversation objected generated based on conversation data received via an email communication channel or any other communication channel type or modality.

In some examples, the CRM system may receive a request for the LLM to perform an action. That is, a user of the CRM system may submit a request to the CRM system for the CRM system (e.g., via the LLM) to perform the action. For instance, the request may comprise requesting the CRM system to perform the action based on conversation data represented by a common conversation object. The user may submit the request by verbally commanding (e.g., speaking—audio data) the system to perform the action, by interacting with a user device that uses the system (e.g., clicking or touching a user interface object within the CRM system, typing and/or submitting text to a text entry box within the CRM system, etc.), etc. In some examples, the request may further include an instruction to guide the CRM system (e.g., the LLM) to perform the action. The action may include, without limitation, summarizing data, synthesizing data, generating documents, responding to question(s) and/or prompt(s), etc. The techniques discussed herein may thus comprise, for example, generating, based at least in part on a common conversation object, a prompt that instructs the LLM to extract a customer contact reason(s) from the common conversation object. In one example, the CRM system may generate the following example prompt, substantially in the form of a JSON object, including instructions to guide the LLM in extracting one or more customer contact reasons from a common conversation object as provided below:
PROMPT_EXTRACT_CONTACT_REASON='''

You are an AI assistant specializing in call center conversation analysis. Your job is to summarize call center conversations in the provided <CONVERSATION> below.

Respond using the JSON format:

```
{{
  “issue_mentioned”: “<1 or 0>”,
  “contact_reason”: “<customer contact reason or None>”,
}}
<RULES>
```

| | |
|---|---|
| 1. | Review the CONVERSATION and skip over the utterances related to greetings, poor call |
| | quality, and information validation (e.g., account numbers, email addresses, names, social |
| | security numbers, etc.). |
| 2. | Identify whether there was a customer service topic mentioned. Think carefully before you |
| | respond. If there was a customer service topic mentioned, set “issue_mentioned” to “1.” |
| | Otherwise, set “issue_mentioned” to “0.” |
| 3. | If “issue_mentioned” is “0”, then set “contact_reason” to “None.” |
| 4. | If “issue_mentioned” is “1”: |

Summarize the primary customer issue with 1 sentence in “contact_reason”.

| | |
|---|---|
| 5. | Do not include your organization's name in your response. |

<RULES>
<CONVERSATION>
{input}
</CONVERSATION>
Response (JSON Only): ”’

In the above example, the LLM is prompted to provide its response within the context of call center conversation analysis. Particularly, the LLM is instructed that it is an AI assistant tasked with summarizing call center conversations. That is, in the example prompt above, the LLM has been assigned a role (or persona) to guide the LLM in generating responses that fit the expected behavior and knowledge of the role (i.e., “an AI assistant specializing in call center conversation analysis”). Accordingly, the LLM may be configured to provide contextually accurate responses for downstream use within a CRM environment. The techniques disclosed herein may therefore improve the efficiency and relevancy of CRM systems that leverage LLMs by helping the LLM(s) to quickly focus on the desired task and generate relevant outputs without unnecessary processing steps (such as interpreting vague language contained in the conversation). Though, the LLM of various examples may be configured to provide responses according to any suitable prompting scheme, including but not limited to few-shot prompting, chain-of-thought prompting, prompt chaining, or the like or any combination thereof.

As shown above, the CRM system may generate input data to input into the LLM based on the request. In some examples, the CRM system may generate the input data based on the common conversation object. For instance, the CRM system may generate or retrieve the common conversation object and use all or a portion of the common conversation object as the input data. In some examples, the CRM system may identify non-essential data within the input data (e.g., within the common conversation object). Non-essential data may include, in some instances, data related to conversations and/or portions of conversations that are not customer-initiated. For example, non-essential data may include portions of conversation data corresponding to, identity verification, pleasantries between a customer and an agent (e.g., a greeting, conversation about the weather, etc.), etc., but not otherwise corresponding to the customer's contact reason. Accordingly, non-essential data may constitute data that an administrator of the CRM system does not want the LLM to interface with because that non-essential data would not result in the LLM being able to more accurately identify relevant common conversation objects. As such, the CRM system may identify and/or filter the non-essential data in the input data. In at least one example, the CRM system may identify and/or filter the non-essential data in one or more pre-processing operations implemented via an instruction statement contained in the LLM prompt. That is, in at least one example, the CRM system may pass to the LLM an entire common conversation object.

Returning to our above banking call center example, the CRM system may identify, within the previously generated common conversation object and based on the above example prompt, the following non-essential conversation data. In the below example, the identified non-essential conversation data includes utterances related to greetings, pause words, repetitive utterances, information validation (e.g., account numbers, email addresses, names, social security numbers and the like), etc. For ease of understanding, the identified non-essential conversation data is represented in bolded type.

```
{
    “speaker _labels”: {
            “speaker1”: “AGENT”,
            “speaker2”: “CUSTOMER”
  },
“transcript”: [
      {
          “text”: “Thank you for calling. This is <AGENT_{—}NAME>. May I please have the full
              name and email associated with your account?”,
        “speaker”: “AGENT”,
      “timestamp”: “00:00:05”
      },
    {
    “text”: “My name's <CUSTOMER_{—}NAME>.”,
    “speaker”: “CUSTOMER”,
    “timestamp”: “00:00:10”
    },
    {
    “text”: “Okay. Can you just confirm the email, date of birth and the last four of your
              social please?”,
    “speaker”: “AGENT”,
    “timestamp”: “00:00:15”
    },
  {
  “text”: “Okay. <CUSTOMER_{—}EMAIL>. Um um, <CUSTOMER_{_{—}}_{SSN>, and my birthday}
            is <CUSTOMER BIRTHDAY>.”,
    “speaker”: “CUSTOMER”,
    “timestamp”: “00:00:20”
    },
  {
    “text”: “Okay. How can I help you out?”,
    “speaker”: “AGENT”,
  “timestamp”: “00:00:23”,
  },
  {
  “text”: “I I worked Thursday. Per facility and Jay and they still haven't paid me.”,
    “speaker”: “CUSTOMER”,
    “timestamp”: “00:00:31”,
    },
  {
  “text”: “Okay, let me take a look at me Just a moment. So Thursday being
  let me see the 25^{th}.”,
    “speaker”: “AGENT”,
    “timestamp”: “00:00:40”,
    },
  {
  “text”: “Yeah.”,
    “speaker”: “CUSTOMER”,
    “timestamp”: “00:00:41”,
  },
  {
  “text”: “Okay, just a moment. Okay, so it looks like they have not, um, resolve that invoice yet
            So since it's past the 48 hours, I'm gonna go ahead and escalate this for you.”,
  “speaker”: “AGENT”,
  “timestamp”: “00:00:51”
  }
  ]
}
```

Based on the above example input data and prompt, the LLM may determine that a customer services topic was mentioned—i.e., “I worked Thursday [. . . ] and they still haven't paid me.” Accordingly, the LLM may proceed to perform the requested task of summarizing this customer issue with one sentence.

In some circumstances, it may be presumed that conversation data extracted by the CRM system is proportional (or at least not highly disproportionate) by source communication channel type (e.g., approximately 33% of conversation data originating from each of voice communication channels, messaging communication channels, and email communication channels). Accordingly, it may be observed that groups (e.g., names, topics, etc.) of similar contact reasons (also referred to herein as “clusters”), are proportional to the raw data. In other words, the techniques described herein may ensure that, when the volume of extracted conversation data is not highly dependent on channel type of the source communication channel, contact reasons that are substantively similar are clustered together regardless of their source communication channel. In turn, the CRM system of various examples may accurately identify contact reasons that are source channel-dependent (e.g., occurring only or primarily in a particular source channel modality) are grouped together in a channel-specific cluster. One non-limiting but illustrative example of a channel-specific contact reason may be that a majority (e.g., 70%, 75%, 80%, etc.) of contact reasons summarized by the CRM system to pertain to “trouble logging into the app,” originated via a voice communication channel.

However, a CRM system of various examples may be configured to account for variations in channel volume. In such circumstances, for instance, extracted conversation data may be disproportional—by volume—according to channel type of the source communication channel. In some examples, the extracted conversation data may be moderately disproportional, highly disproportional or the like (e.g., approximately 10% of conversation data originating from a first channel type (e.g., voice), approximately 20% of conversation data originating from a second channel type (e.g., messaging), and 70% of conversation data originating from a third channel type (e.g., email). It will be understood that the foregoing proportions are merely illustrative and not intended to be limiting. The CRM system can be configured to account for such variation in channel volume by ensuring that contact reasons extracted from underrepresented channel types (i.e., channel types representing statistically lower-volume sources of extracted conversation data) are proportionately represented in clusters.

In some examples, the CRM system may be configured to employ a weighted clustering algorithm, such as a weighted k-means clustering algorithm or the like, to re-scale the extracted conversation data and thereby increase the likelihood that a generated cluster is valid. In such circumstances, the CRM system may segment the extracted conversation data and assign one or more weights based on various factors. For instance, the CRM system of various examples may be configured to segment the extracted conversation data (e.g., each extracted contact reason) based on its source channel, and assign weight values to ensure that contact reasons extracted from lower-volume communication channels are not overshadowed during the clustering process by contact reasons extracted from higher-volume communication channels. In at least one example, the CRM system may assign to extracted contact reasons weight values that are inversely proportional to channel volume. That is, in at least one example, the CRM system may be configured to employ an inverse weighted k-means clustering algorithm, or the like, to account for variations in channel volume.

In some examples, the CRM system may be configured to constrain one or more metrics, variables, criteria, or the like associated with extracted contact reasons. For instance, the CRM system of various examples may be configured to apply one or more constraints to extracted contact reasons in order to quantify, minimize or otherwise ascertain an uncertainty measure associated with the extracted contact reasons. In at least one example, the CRM system may be configured to constrain the source channel(s) from which contact reasons are extracted. In such circumstances, the CRM system may be configured, for instance, to constrain the aforementioned source channels according to one or more diversity metrics such as Shannon entropy or the like. The CRM system of such examples may generate or otherwise obtain one or more groups or “clusters” of contact reasons. The CRM system may calculate or otherwise determine, for each cluster, a distribution of source channels and/or source channel types. Based on determining the distribution of source channels and/or source channel types, the CRM system may rank or otherwise order each cluster according to the diversity metric. For instance, a cluster having a minimum entropy may be identified as a least diverse cluster. Based on identifying the least diverse cluster, the CRM system may identify a contact reason belonging to the least diverse cluster having a lowest certainty (e.g., as indicated by a probability or the like). The contact reason identified as having the lowest certainty may be reassigned (e.g., by the CRM system or a component thereof) to a cluster having a next-lowest entropy. The CRM system may perform such steps algorithmically until a cluster size of any particular cluster falls below a threshold cluster size. The CRM system may determine that one or more clusters are “sufficiently” diverse according to a predetermined threshold.

In at least one example, the CRM system can identify and “lock” or otherwise invalidate those clusters pertaining to channel-specific contact reasons. In this way, the CRM system may be configured to ensure that generated clusters accurately represent or are otherwise proportional with raw conversation data. One non-limiting but illustrative example of such a channel-specific contact reason could be “cannot log in,” (originating only in voice communication channels) because a user cannot otherwise log into other modalities (such as email, etc.) to request assistance. In some cases, “locked” clusters are removed, disabled or otherwise invalidated by the CRM system from having new contact reasons assigned thereto. In some examples, the CRM system may perform the aforementioned “lock and remove” process prior to ranking clusters according to the diversity metric.

As illustrated by these examples, the techniques described herein can improve the functioning, efficiency, and overall user experience of the CRM system. That is, the techniques described herein may enable the CRM system to improve the efficiency and quality of transcript pre-processing when leveraging LLMs. Thus, the techniques described herein may enable the CRM system to reduce the perceived latency of systems that leverage LLMs. As just one example, by providing clear and concise instructions when leveraging the LLM(s), a CRM system may help the LLM(s) to quickly identify information that is relevant and/or irrelevant for generating its response. In this way, the LLM(s) may generate the desired response(s) without having to process unnecessary data. Accordingly, computational overhead is reduced and the desired response(s) are generated faster. Further, the techniques described herein may provide for a more robust CRM platform, because the task of extracting customer contact reasons can be generalized across diverse communication channels. The techniques disclosed herein thus overcome the need for CRM systems to utilize different extractors based on channel type (e.g., utilizing a rules-based extractor for text-based communication channels but not for voice-based communication channels). Moreover, the techniques described herein are easily extended to new communication channel types by adjusting the instructions provided to the LLM(s). Accordingly, the techniques described herein may result in an increased and/or enhanced user experience.

The following detailed description of examples references the accompanying drawings, which illustrate specific examples in which the techniques described herein can be practiced. The examples are therefore intended to describe aspects of the systems and methods in sufficient detail to enable those skilled in the art to practice the techniques. Other examples can be utilized and changes can be made without departing from the scope of the disclosure. The following detailed description is, therefore, not to be taken in a limiting sense. The scope of the disclosure is defined only by the appended claims, along with the full scope of equivalents to which such claims are entitled.

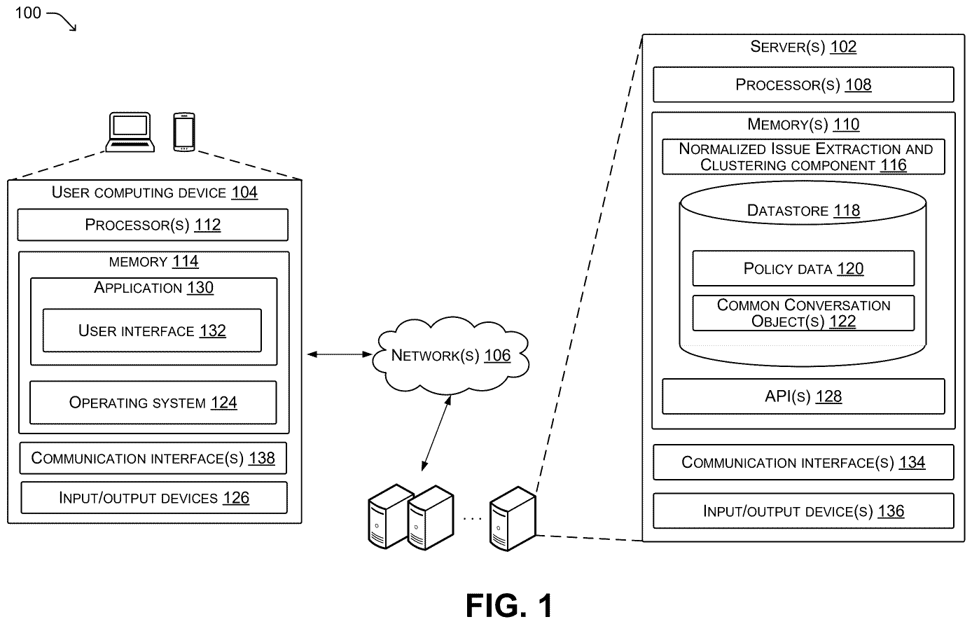

FIG. 1 illustrates an example computing environment 100 for performing the techniques described herein. The techniques discussed herein may be used in a variety of environments and for a variety of uses, although various non-limiting examples given herein discuss a customer service and/or customer relations management environment. In additional or alternate examples, the computing environment 100 may comprise computing devices used for sales-based systems, marketing, commerce, healthcare, communication platforms, chat engines, cybersecurity, search engines, multi-agent/agentic machine-learned model pipeline(s) and/or cluster(s), machine-learned model training, cloud/distributed computing or massive computing efficient data storage and/or retrieval, and/or the like.

In at least one example, the example computing environment 100 can include one or more computing devices, such as server(s) 102 and/or a user computing device(s) 104. By way of example and not limitation, the server(s) 102 may be representative of servers for hosting the software, hardware, containers, and/or the like to implement at least part of the techniques discussed herein. For example, the server(s) 102 may host (e.g., store and/or execute) system software. The user computing device(s) 104 may be representative of user computing device(s) associated with a first user (i.e., a first “client device”).

The server(s) 102 may comprise one or more individual servers or other computing devices that may be physically located in a single central location or may be distributed at multiple different locations. The server(s) 102 may be hosted privately by an entity administering all or part of the computing environment 100 (e.g., a utility company, a governmental body, a distributor, a retailer, a manufacturer, etc.), or may be hosted in a cloud environment, or a combination of privately hosted and cloud hosted services. In some examples, the functional components and/or data discussed herein can be implemented on a single server, a cluster of servers, a server farm or data center, a cloud-hosted computing service, a cloud-hosted storage service, and so forth, although other computer architectures can additionally or alternatively be used. Moreover, the server(s) 102 may comprise hardware and/or software containers accessible to different tenants with access to the server(s) 102.

The user computing device(s) 104 may be any suitable type of computing device, e.g., portable, semi-portable, semi-stationary, or stationary. Some examples of the user computing device(s) 104 can include a tablet computing device, a smart phone, a mobile communication device, a laptop, a netbook, a desktop computing device, a terminal computing device, a wearable computing device, an augmented reality device, an Internet of Things (IOT) device, or any other computing device capable of sending communications and performing the functions according to the techniques described herein. In some examples, the user computing device(s) 104 may comprise distributed computing devices, server(s), etc.

In some examples, the server(s) 102 and/or user computing device(s) 104 may be configured to transmit network packages therebetween via network(s) 106. The network(s) 106 can include, but are not limited to, any type of network known in the art, such as a local area network or a wide area network, the Internet, a wireless network, a cellular network, a local wireless network, Wi-Fi and/or close-range wireless communications, Bluetooth®, Bluetooth Low Energy (BLE), Near Field Communication (NFC), a wired network, cellular network, or any other such network, or any combination thereof. The network(s) 106 may comprise a single network or collection of networks, such as the Internet, a corporate intranet, a virtual private network (VPN), a local area network (LAN), personal area network (PAN), metropolitan area network (MAN), a wireless local area network (WLAN), a cellular network, a wide area network (WAN), a metropolitan area network (MAN), or a combination of two or more such networks, over which the user computing device(s) 104 may transmit data to and/or receive data from the server(s) 102 (such as, for example, via a communication platform). Components used for such communications can depend at least in part upon the type of network, the environment selected, or both. Further, the network(s) 106 may include a public network, such as the Internet, a private network, such as an intranet, or combinations thereof, and may utilize a variety of networking protocols now available or later developed including, but not limited to TCP/IP based networking protocols. For instance, the networking protocol may be customized to suit the needs of a particular communication system. In some embodiments, the protocol is a custom protocol of JSON objects sent via a Websocket channel. In some embodiments, the protocol is JSON over RPC, JSON over REST/HTTP, and the like.

The server(s) 102 and the user computing device(s) 104 described herein may include one or more processors and/or memory. Specifically, in the illustrated example, server(s) 102 may include processor(s) 108 and memory 110 and user computing device(s) 104 include processor(s) 112 and memory 114.

By way of example and not limitation, the processor(s) 108 and/or 112 may comprise one or more central processing units (CPUs), graphics processing units (GPUs), tensor processing units (TPUs), field-programmable gate arrays (FPGAs), and/or process-acceleration devices such as application-specific integrated circuits (ASICs) or any other device or portion of a device that processes electronic data to transform that electronic data into other electronic data that may be stored in registers and/or memory. In some examples, integrated circuits (e.g., ASICs, etc.), gate arrays (e.g., FPGAs, etc.), and other hardware devices may also be considered processors in so far as they are configured to implement encoded instructions. For example, the processor(s) 108 and/or 112 can be one or more hardware processors and/or logic circuits of any suitable type specifically programmed or configured to execute the algorithms and processes described herein. The processor(s) 108 and/or 112 can thus be configured to fetch and execute computer-readable instructions stored in non-transitory computer-readable media (such as memory 110 and/or 114), which can program the processor(s) to perform the functions described herein.

The memory 110 and/or 114 may comprise one or more non-transitory computer-readable media and may store software applications, instructions, programs, and/or data to implement the methods described herein and the functions attributed to the various systems. In various implementations, the memory may be implemented using any suitable memory technology, such as static random-access memory (SRAM), synchronous dynamic RAM (SDRAM), nonvolatile/flash-type memory, RAM, ROM, EEPROM, flash memory, optical storage, solid state storage, magnetic tape, magnetic disk storage, RAID storage systems, storage arrays, network attached storage, storage area networks, cloud storage, or any other medium for storing information. The architectures, systems, and individual elements described herein may include many other logical, programmatic, and physical components, of which those shown in the accompanying figures are merely examples that are related to the discussion herein. The memory 110 and/or 114 can be used to store any number of software/functional components that are executable by the processor(s) 108 and/or 112, respectively. In many implementations, these functional components comprise instructions or programs that are executable by the processor(s) 108 and/or 112 and that, when executed, specifically configure the processor(s) 108 and/or 112 to perform the actions attributed to server(s) 102 and/or user computing device(s) 104, according to the discussion herein.

For example, server(s) 102 may comprise a memory 110 storing the normalized issue extraction and clustering component 116. As described throughout, the normalized issue extraction and clustering component 116 may leverage a common conversation object(s) to identify customer contact reasons within conversation data that is received via diverse communication channels and/or cluster the customer contact reasons according to similarity. In some examples, the normalized issue extraction and clustering component 116 may receive a request to perform such an action or sub-action. The normalized issue extraction and clustering component 116 may leverage one or more generative machine learned models (e.g., one or more LLM models, such as autoregressive models, transformer-based models, encoder-decoder models, pre-trained and fine-tuned models, multilingual models, or the like) to assist in performing one or more aspects of the requested actions. For instance, the normalized issue extraction and clustering component 116 may leverage one or more prompt-based LLMs to assist in performing one or more aspects of determining a customer contact reason(s) and/or clustering customer contact reasons. Accordingly, the normalized issue extraction and clustering component 116 may “hydrate” the LLM prompt with a common conversation object by reshaping and/or organizing data to input (e.g., input data including a prompt) into the LLM.

When generating the input data, the normalized issue extraction and clustering component 116 can determine which types of text data are to be filtered from the LLM (e.g., non-essential conversational content) and which types of text data are capable of being input directly into the LLM. In some examples, the normalized issue extraction and clustering component 116 can receive and/or directly access policy data 120. In one example, the policy data 120 can indicate that all text data corresponding to greetings and salutations should be ignored. As another example, the issue extraction component 116 can receive or access policy data 120 that indicates that all text data corresponding to automated messages and identity verification should be ignored. Though, it will be understood that the aforementioned are merely examples of such policies, and that the present disclosure contemplates different and/or other policies herein. In some other cases, the normalized issue extraction and clustering component 116 may parse the input data to determine whether a portion of the conversation data corresponds to data that is to be filtered. For instance, as discussed above, the input data may comprise a prompt or instruction that guides the LLM (e.g., the normalized extraction component 116) on which utterances to “skip over.” Based on a given instance of text data and the policy, the normalized issue extraction and clustering component 116 can determine whether or which portions of the conversation data to input to the LLM.

In some examples, the policy may be represented as an instruction statement in the LLM prompt. Thus, the issue extraction component 116 can organize the input data such that the policy is clearly delineated as comprising a portion of the request or task to be performed by the LLM. In some examples, the normalized issue extraction and clustering component 116 can generate the input data to comprise a positive action verb such as “ignore,” “exclude,” “filter,” or the like, followed by the type of text data that the LLM should not consider in generating its output. An example of one such instruction statement representing a policy could be “Ignore all greetings, salutations, automated messages, connection attempts, and identity verification conversation while completing this task.” In some examples, the policy may be reflected in a vocabulary of the LLM. For instance, an administrator or user of a CRM system may refrain from providing certain classifications of text for the LLM to train on. Based on generating the input data, the issue extraction component 116 can input the input data into the LLM, which may be configured to output a response based on the input data (i.e., based on the prompt and the input data).

The memory 110 may additionally or alternatively comprise a portion of memory 110 (e.g., one or more memories or a portion of a single memory) that collectively forms a datastore 118 (e.g., a database). In some examples, the datastore 118 can be integrated with the server(s) 102, as shown in FIG. 1. In other examples, the datastore 118 can be located remotely from the server(s) 102 and can be accessible to the server(s) 102 and/or user device(s), such as the user computing device(s) 104. The datastore 118 can comprise multiple databases, which can include policy data 120, and/or common conversation object(s) data 122. Additional or alternative data may be stored in the data store and/or one or more other data stores.

In some examples, the policy data 120 may include one or more policies that have been set or otherwise generated by one or more companies, users, admins, and/or any other type of user. As noted above, the policy data 120 may include a list of one or more classifications of text data that are to be disregarded such that the data associated with the classification is not input to (or considered by) the LLM in generating its output.

In some examples, common conversation object data 122 may comprise conversation data that is parsed from heterogeneous communication channels. As such, in some cases, the common conversation object data 122 may comprise unstructured text data. In some other cases, the common conversation object data 122 may include semi-structured text data. For instance, the common conversation object data 122 may be both human-readable and machine-readable. In some cases, the common conversation object data is stored as one or more JavaScript Object Notation (JSON) files.

It will be appreciated that the terms “datastore,” “database,” “repository,” and “network database” may be used interchangeably in areas of the present disclosure. As used herein, the terms “data,” “content,” “digital content,” “digital content object,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and/or the like. Moreover, data may be transmitted, received, or otherwise exchanged as individual “data objects” comprising interrelated data. Data objects may constitute single bits of data or large quantities of interrelated data, such as substantive data (e.g., the underlying content to be conveyed through a communication) and associated metadata (e.g., data not otherwise considered to be substantive data, encompassing characteristics of the substantive data and/or the relevant exchange (e.g., the identity of the user sending the data, the identity of the user receiving the data, the time/date when the data was sent, formatting to be associated with the exchanged substantive data, the file type of the data object, and/or the like).

The memory 110 may additionally or alternatively store application programming interface(s) (API(s) 128), hypervisor(s), container orchestration system(s), an operating system, and/or container (unillustrated). The API(s) 128 may expose back-end functions and/or services hosted by the server(s) 102 to the user computing device(s) 104 and/or different component(s) hosted by the server(s) 102 without transferring the functions/services/software to those computing device(s) and/or by accomplishing the functions and/or services at the server(s) 102. As relates to the instant discussion, this may comprise API(s) for receiving indications from a user (e.g., as part of an API call), or from different ones of the components.

In some examples, software executed at the user computing device(s) 104, such as a client application 130, may generate API call(s) to the API(s) 128 and/or any of the component(s) discussed herein may transmit call(s) to the API(s) 128 and/or receive responses from the API(s) 128. For example, a user interface 132 executed by a client application 130 may display actuatable/selectable options to request that the client application 130 perform an action. In some examples, the client application 130 may interface with the API(s) 128 to authenticate a user and grant or deny the user access to a portion of the datastore 118 and/or data masking component 116.

The memory 110 may additionally or alternatively an operating system and/or container. In some examples, one or more containers may be instantiated by a cloud orchestrator and may run the operating system and may execute one or more instances of the API(s) 128 and the data masking component 116 and may permit access to a portion of the datastore 118 according to permissions associated with a user and an organization associated with the container.

In some examples, the server(s) 102 may further comprise communication interface(s) 134, which can include one or more interfaces and hardware components for enabling communication with various other devices (e.g., the user computing device(s) 104), such as over the network(s) 106 or directly. In some examples, the communication interface(s) 134 can facilitate communication via WebSockets, APIs (e.g., using API calls), Hypertext Transfer Protocols (HTTPs), etc. The server(s) 102 can further be equipped with various input/output devices 136 (e.g., I/O devices). Such input/output devices 136 can include a display, various user interface controls (e.g., buttons, joystick, keyboard, mouse, touch screen, etc.), audio speakers, connection ports, and so forth.

In at least one example, the user computing device(s) 104 can include processor(s) 112, memory 114, communication interface(s) 138, and/or input/output device(s) 126. The memory 110 may store and execute a client application 130 and/or an operating system 142. In some examples, the client application 130 may be configured to authenticate a user to access data and/or services hosted by the server(s) 102. The API(s) 128 may filter the users and/or orgs accessible depending on permissions granted to a type of user profile and/or an organization associated with the user. In at least one example, a user profile to which a user authenticates can include permission data associated with permissions of individual users of the platform. In some examples, permissions can be set automatically or by an administrator of the platform, an employer, enterprise, organization, or other entity that utilizes the platform, a team leader, a group leader, or other entity that utilizes the platform for communicating with team members, group members, or the like, an individual user, or the like. Permissions associated with an individual user can be mapped to, or otherwise associated with, an account or profile. In some examples, permissions can indicate which users can communicate directly with other users, which channels a user is permitted to access, restrictions on individual channels, which workspaces the user is permitted to access, restrictions on individual workspaces, and the like. In at least one example, the permissions can support the platform by maintaining security for limiting access to a defined group of users. In some examples, such users can be defined by common access credentials, group identifiers, or the like, as described above.

In some examples, the client application 130 may additionally or alternatively comprise instructions executable by one or more processors to provide a user interface 132. For example, the user interface 132 may comprise a graphical user interface (GUI), that the instructions may cause to be displayed via at least one of the input/output device(s) 140. In at least one example, the client application 130 can be a mobile application, a web application, a database interface (e.g., such as an application that presents a SQL or other database interface), or a desktop application. For example, a computing device of the one or more user computing device(s) 104 may access the API(s) 128 via a web browser or stand-alone application (either of which may be part of or host the client application 130) that communicates via network(s) 106 with API(s) 128.

In at least one example, the operating system 124 can manage the processor(s) 112, memory 114, hardware, software, etc. of the server(s) 102.

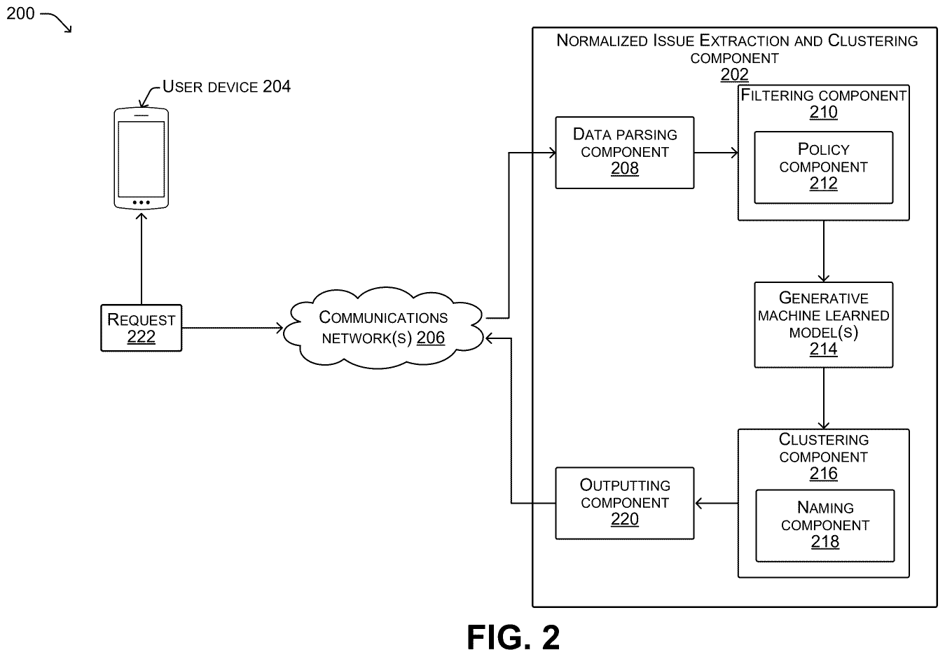

FIG. 2 depicts a block diagram 200 illustrating the interactions of components of a normalized issue extraction and clustering component 202 configured to extract primary customer contact reasons from conversation data associated with multiple, different communication channel types.

In some examples, the example block diagram 200 may be implemented with and/or in conjunction with a CRM system. For instance, the CRM system may be implemented with and/or in conjunction with a communication platform, a search engine, a sales-based platform, a chatbot engine, and/or any other type of platform or system. In this example, the block diagram 200 may include one or more user devices 204 configured to communicate with a CRM system via a communication network 206. Additionally, the example block diagram 200 may include a normalized issue extraction and clustering component 202 configured to extract primary customer contact reasons from conversation data associated with multiple, different communication channel types. In some examples, the normalized issue extraction and clustering component 202 may include a data parsing component 208 configured to identify the non-essential conversation data associated with the input data, a filtering component 210 configured to constrain the non-essential conversation data from being input directly to the LLM, a generative machine learned model(s) component 214 configured to perform various operations using one or more LLMs, a clustering component 216 configured to classify output from the generative machine learned model(s) component 214, and/or an outputting component 220 configured to cause the LLM output to be output via the user device 204.

In some examples, the example block diagram 200 may include one or more user devices 204 configured to communicate with a normalized issue extraction and clustering component 202. The example block diagram 200 includes a user device 204. In this example, the user device 204 may be a mobile phone; however, in other examples, the user device 204 may be any other type of mobile device (e.g., wearable, tablet, etc.). In this example, the user device 204 may communicate with the normalized issue extraction and clustering component 202 via the communication network(s) 206, which may be similar to the communication network(s) 106 as described with reference to FIG. 1. In some examples, a user may use the user device 204 to send a request 222 to a system that includes the normalized issue extraction and clustering component 202. In such cases, the request 222 may include user data (e.g., user profile, username, user role, user organization/company, etc.) and/or the requested action for the system to perform. In the depicted example, the request 222 may include instructions for the system to perform a task that relies on an LLM. In such cases, the normalized issue extraction and clustering component 202 may generate input data to input to the LLM while also ensuring that non-essential conversation data is filtered such that the non-essential conversation data is not input to the LLM.

In some examples, the normalized issue extraction and clustering component 202 may include a data parsing component 208 configured to transform or otherwise format conversation data as one or more common conversation objects. That is, the data parsing component 208 may organize input data to be input into the LLM(s). The data parsing component 208 may analyze the input data and identify data that may indicate non-essential conversation and/or data that is detrimental to the generation of an output of the LLM(s). In some cases, a user and/or organization may indicate which types of data are considered non-essential conversation. As an example, the user and/or organization may indicate that conversation data indicative of pre-written scripts is non-essential conversation. Accordingly, in such instances, the data parsing component 208 may flag conversation data indicative of an agent validation as being non-essential conversation. Of course, in other examples, the system may include a list of one or more types of conversation data that may be considered non-essential which may include greetings and salutations (e.g., “hey,” “hi,” “hello,” etc. ,) and/or other short or choppy utterances (e.g., “umm”, “uhh,” “huh,” etc.), monologues (e.g., data indicative of “one-sided” conversations such as user attempts to connect with an agent, etc.), and/or any other type of data.

In some examples, the normalized issue extraction and clustering component 202 may include a filtering component 210 configured to filter the non-essential conversation data. That is, the filtering component 210 may be configured to determine what data is considered by the LLM in generating its output. In some examples, the filtering component generates a prompt that delineates the task to be completed by the LLM. The filtering component 210 may receive the input data and/or the references to the non-essential conversation data associated therewith from the data parsing component 208. The filtering component 210 may filter the non-essential conversation data by instructing the LLM(s) to disregard the non-essential conversation data when generating its output. When filtering the non-essential conversation data, a policy component 212 of the filtering component 210 may retrieve or otherwise determine a policy to be applied to the input data. As described above, one or more of admins, users, etc. may determine a policy that defines which types of conversation data are to be filtered such that the associated data is not input to or considered by the LLM. For example, an admin may set a policy for an organization that indicates that data indicative of a communication channel type (e.g., pre-generated text—indicative of a webform channel type, call quality data—indicative of a voice call channel type, etc.) are to be filtered. In some cases, a policy may be represented as an explicit list of words or phrases or the like to be filtered out by the LLM such that they are disregarded when the LLM generates its response. Additionally, the policy component 212 may identify a policy that corresponds to (or is attached with) the input data itself. That is, in some examples, the policy may be represented as an instruction statement in the LLM prompt. As such, the filtering component 210 may send the input data comprising the policy to the generative machine learned model(s) component 214.

The normalized issue extraction and clustering component 202 may include a generative machine learned model(s) component 214 configured to perform various operations using one or more LLMs. As noted above, the generative machine learned model(s) component 214 may include one or more LLMs that may be used to perform various tasks and/or operations. Accordingly, the generative machine learned model(s) component 214 may receive the input data (e.g., conversation data, policy data, prompt data, etc.) and input the input data into an LLM. The LLM may be trained to output a response or output data. As shown, the generative machine learned model(s) component 214 may send the LLM output to the clustering component 216.

The normalized issue extraction component 202 may include a clustering component 216 configured to classify output from the generative machine learned model(s) component 214. That is, the clustering component 216 may receive the LLM output (e.g., one or more customer contact reasons) from the generative machine learned model(s) component 214 and classify or “name” the output. In some examples, classifying or “naming” the output comprises one or more topic modeling operations. In this case, by sending the LLM output to the clustering component 216, the normalized issue extraction and clustering component 202 may ensure that the output(s) of the generative machine learned model(s) 214 are generalizable or can otherwise be compared to or evaluated regarding one another. As shown in FIG. 2, the clustering component 216 may comprise a naming component 218 configured to group or otherwise organize similar output of the generative machine learned model(s) 214. While not explicitly illustrated, in some examples, the normalized issue extraction and clustering component 202 may comprise a plurality of clustering components 216. For instance, a first clustering component 216 may be associated with a first granularity or hierarchy level associated with an LLM output—e.g., a cluster of “contact reasons.” Similarly, a second clustering component 216 may be associated with a second granularity or hierarchy level associated with a the LLM output—e.g., a cluster of “topic groups.”

The normalized issue extraction and clustering component 202 may include an outputting component 220 configured to cause the named and/or clustered LLM output to be output via the user device 204. That is, based on receiving the output from the LLM (via the clustering component 216), the outputting component 220 may cause the response to be output to the user device 204. In some examples, the outputting component 220 may cause the response to be displayed via a user interface on the user device 204. In other examples, the outputting component 220 may cause the response to be output via audio on the user device 204.

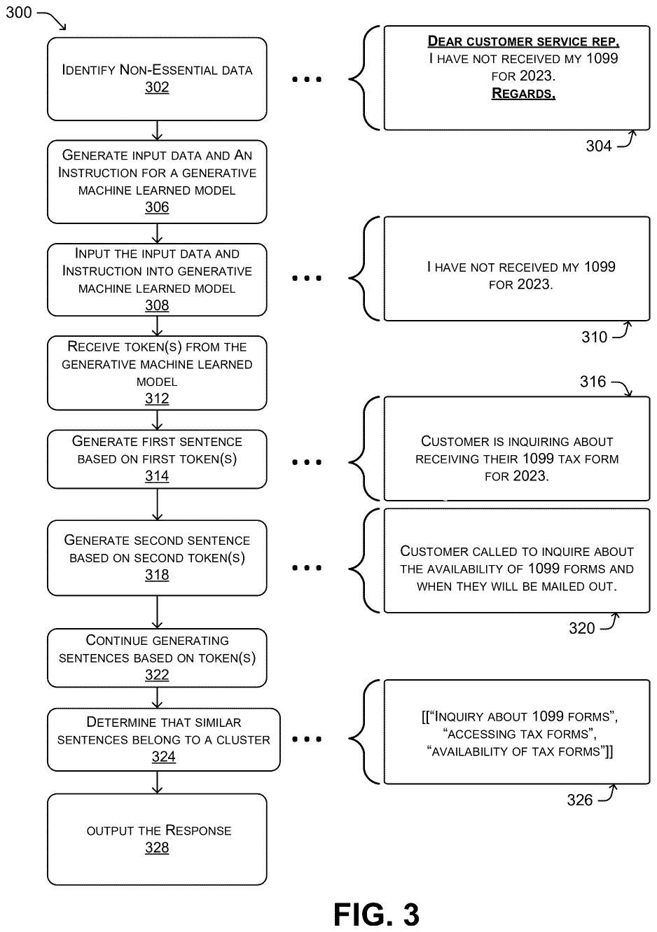

FIG. 3 is a pictorial flow diagram illustrating an example process 300 for disregarding non-essential conversation data and/or clustering similar sentences.

At operation 302, the system can identify non-essential conversation data. As described above, the system may receive a request to perform an operation. The system may rely on one or more LLMs to perform such operations and as such, the system may generate input data to input into the LLM. Accordingly, based on generating the input data, the system may determine whether the input data includes non-essential conversation data. For instance, as described above with reference to the example prompt, the LLM may be instructed to “skip over utterances related to greetings, poor call quality, and information validation (e.g., account numbers, email addresses, names, social security numbers, etc.). For example, the box 304 illustrates non-essential conversation data in the input data. In this example, the system determined that the input data included the following non-essential conversation data: the salutations “Dear Customer Service Rep,” and “Regards.” In the illustrated example, merely for ease of understanding, the identified non-essential data is represented in bolded and underlined type. Though, in examples, other methods of identifying non-essential conversation may be used. For instance, the system can store one or more mappings of known non-essential conversation data in a database associated with the system.

At operation 306, the system may organize, normalize, or otherwise format input data and an instruction for the LLM. In some cases, the input data comprises a common conversation object generated by the CRM system and the instruction. That is, the CRM system may generate an instruction for the LLM to disregard non-essential conversation data if the input data does include such data. Further as described above, the instruction may direct the LLM to format its response by summarizing the primary customer contact reasons identified by the LLM in a single sentence. In this way, the CRM system may help ensure that the extracted primary customer contact reasons are generalizable to other similar issues. That is, the disclosed methodology of constraining the LLM output (e.g., restricting the number of output tokens) may help ensure that the LLM response adheres to the format and/or structure desired by the requesting user. Accordingly, the LLM response of various examples is configured to provide output that is easier to parse and integrate with other applications for downstream use.

At operation 308, the system may input the input data and the instruction into an LLM. That is, the system can input the input data that includes the non-essential conversation data along with the instruction to disregard such non-essential conversation data into the LLM. For example, box 310 illustrates the conversation data that the LLM is to consider in generating its response. In this example, the non-essential conversation data is omitted to illustrate that it is not considered by the LLM. As such, the LLM may be configured to output one or more tokens based only on the conversation data that includes: “I have not received my 1099 for 2023.” That is, the LLM may be configured to decompose or otherwise process the conversation data that includes “I have not received my 1099 for 2023” to generate individual data units based upon which the LLM may perform the requested action. The LLM may output the one or more tokens using any suitable tokenization method (e.g., word tokenization, character tokenization, subword tokenization, etc.). For example, the LLM may be configured in some instances to output smaller tokens (e.g., via character tokenization or subword tokenization wherein each character or subword is assigned a token ID), thereby enabling the LLM to handle a wider range of inputs and lessen a strain on memory resources. In some other instances, the LLM may be configured to output larger tokens (e.g., via word tokenization) such that the conversation data is decomposed into fewer tokens. In such an example, each individual word in the conversation data may be assigned a token ID (for example—the corresponding text “I have not received my 1099 for 2023” can be represented as a sequence of token IDs). By utilizing a word tokenization method, the LLM may be configured to require fewer computational resources during processing.

At operation 312, the system may receive token(s) from the generative machine learned model (or LLM). As indicated above, the LLM may output a subset of a response. That is, the LLM may output one or more tokens at a time (e.g., according to a tokenization method). The LLM may continue to output the token(s) until the entire LLM response has been output.

As noted above, the LLM may output a subset of a response by outputting one or more tokens at a time. Thus, at operation 314, the system may output a first subset of a response that is based on first tokens. That is, based on receiving the first token(s) from the LLM, the system can generate a first subset of a response. As illustrated above, in some examples, the LLM may be instructed to limit its individual responses to a single sentence. The first subset of the response can therefore be a first sentence that summarizes a first topic or theme associated with the first tokens. For example, box 316 illustrates a first sentence based on first tokens. In this example, the first sentence may indicate a first customer contact reason that is extracted from the input data. For instance, a first customer may have initiated the conversation via a voice call communication channel. In this case, the first customer contact reason is: “Customer is inquiring about receiving their 1099 tax form for 2023.”

Again, the LLM may output a subset of a response by outputting one or more tokens at a time. Thus, at operation 318, the system may output a second subset of a response that is based on second tokens. That is, based on receiving second token(s) from the LLM, the system can generate a second subset of a response. The second subset of the response can—based on the above illustrated LLM instruction—be a second sentence that summarizes a second topic or theme associated with the second tokens. For example, box 320 illustrates a second sentence based on second tokens. In this example, the second sentence may indicate a second customer contact reason that is extracted from the input data. For instance, a second customer may have initiated the illustrated conversation via an email communication channel. In this case, the second customer contact reason is: “Customer called to inquire about the availability of 1099 forms and when they will be mailed out.” As discussed in further detail below, by outputting a second subset of a response that is based on second tokens, the CRM system may be able to identify and/or group similar subsets of the LLM response. In an exemplary CRM environment, such operations may be leveraged to identify and group similar customer contact reasons such that a requesting user can assess customer contact reasons regardless of an originating communication channel without having to generate multiple queries.

At operation 322, the system can continue generating sentences based on token(s). That is, the system can continue to perform the operations described in operation 312, operation 314, and/or operation 318 until the entire LLM response has been output to the requesting user.

At operation 324, the system may determine that one or more generated sentences are similar to one another. That is, the system may determine that a topic or theme represented by a generated sentence is similar to a topic or theme represented by one or more other generated sentences.

In some examples, this determination is based on sentence embeddings. As discussed above, the LLM(s) of various examples may generate one or more tokens based on conversation data. The LLM may further determine embeddings (based on the generated one or more tokens) that indicate semantic relationships between the one or more tokens. For instance, the LLM may assign numeric vectors (i.e., embeddings) to each of the one or more generated tokens in order to understand semantic context and relationships between the one or more tokens. For example, a similarity between token embeddings may indicate a semantic similarity such as how commonly tokens are used together or in similar contexts with one another. In some cases, a semantic similarity is represented as the Cosine similarity between embeddings. Further, the LLM may assign embeddings to subsets of the LLM response, the entire LLM response or the like in order to determine semantic similarities therebetween. That is, the LLM may be configured to determine semantic similarities between words, sentences, paragraphs or the like. Though, it should be understood that the CRM system may additionally or alternatively employ other non-LLM neural network-based embedding models to generate and/or assign embeddings such as DistilUSE sentence embedders or the like.

Accordingly, the CRM system may use the sentence embeddings to determine whether the sentence embedding of a first sentence is similar to the sentence embedding of a second sentence. In some examples, a same encoder is used to generate the sentence embeddings as is used to generate the tokens described above. In some examples, the encoder may be a transformer-based model such as a Bidirectional Encoder Representations from Transformers (BERT) model. As shown, the CRM system of the present example may determine, based on the sentence embeddings, that the first sentence illustrated in box 316 is similar to the second sentence illustrated in box 320. As such, in this case, the topic(s) or theme(s) of the first sentence and the second sentence are determined to belong to the group or cluster of topics and/or themes illustrated in box 326. That is, in the illustrated example the CRM system of various examples has leveraged a generative machine learned model (e.g., an LLM) to parse conversation data based on an email conversation and a voice call conversation determine that the two conversations include similar customer contact reasons.

At operation 328, the system may output a response. In some examples, outputting the response may comprise outputting a subset (e.g., less than all) of an entire response from the LLM. Further, the LLM may be trained to output the response in a streaming manner. That is, the LLM may output one token (e.g., unit of data (e.g., letter, number, symbol, etc.)) or a group(s) of tokens (e.g., two or more characters, a full sentence or the like—but less than the entire response) at a time. Still, the LLM may be trained to output a complete response. Further, the LLM may be trained to output subsequent responses based on subsequent requests. For instance, after extracting customer contact reasons from conversation data based on a first request, the LLM may be utilized to summarize groups of similar customer contact reasons and then “name” them. Based on receiving the response (e.g., the tokens), the CRM system may perform one or more operations on the token(s) and output (or stream) the token(s) to the user profile. For instance, the CRM system may process the response and present the response via a user interface associated with the user profile.

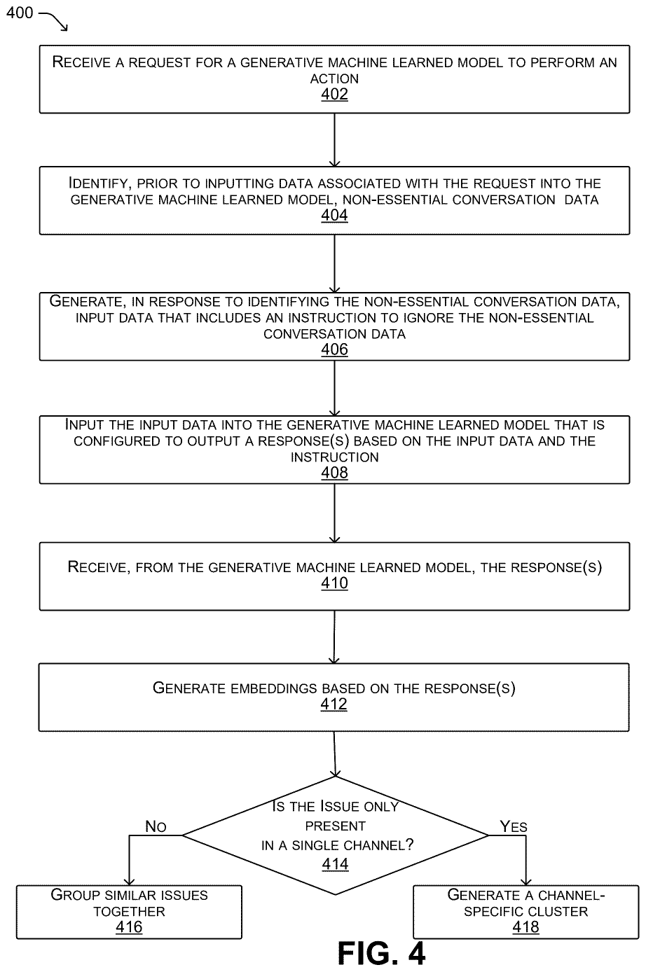

FIG. 4 is a flow diagram illustrating an example process 400 of receiving a request for a generative machine learned model to perform an action, generating input data to input to the generative machine learned model, and outputting a response based on inputting the input data to the generative machine learned model. For convenience and ease of understanding, the example process 400 illustrated in FIG. 4 is described with reference to components described above with reference to the example environment 100 shown in FIG. 1. However, the process illustrated in FIG. 4 is not limited to being performed using the components described above with reference to the example environment 100. Moreover, the components described above with reference to the example environment 100 are not limited to performing the processes illustrated in FIG. 4

Process 400 is illustrated as collections of blocks in a logical flow diagram, representing sequences of operations, some or all of which can be implemented in hardware, software, or a combination thereof. In the context of software, the blocks represent computer-executable instructions stored on one or more computer-readable media that, when executed by one or more processors, perform the recited operations. Generally, computer-executable instructions include routines, programs, objects, components, encryption, deciphering, compressing, recording, data structures, and the like that perform particular functions or implement particular abstract data types. The order in which the operations are described should not be construed as a limitation. Any number of the described blocks can be combined in any order and/or in parallel to implement the processes, or alternative processes, and not all of the blocks need to be executed in all examples. For discussion purposes, the processes herein are described in reference to the frameworks, architectures and environments described in the examples herein, although the processes may be implemented in a wide variety of other frameworks, architectures or environments.

At operation 402, the process 400 can include receiving a request for a generative machine learned model to perform an action. That is, a user profile may submit a request to the system (e.g., a CRM system) for the system to perform an action. The user profile may submit the request by verbally commanding (e.g., speaking - audio data) the system to perform the action, interacting with a user device that uses the system (e.g., clicking or touching a user interface object within the system, typing and/or submitting text to a text entry box within the system, etc.), etc. In some examples, the request may include an instruction for the system (or LLM) to perform an action. The actions may include summarizing data, synthesizing data, generating documents, responding to a question or prompt, receiving data, determining one or more topics or sub-topics associated with a corpus of conversation data, etc. In one example, the action may include extracting one or more customer contact reasons from conversation data associated with various types of communication channels.

At operation 404, the process 400 can include identifying, based on the request, and prior to inputting data associated with the request into a generative machine learned model, non-essential conversation data associated with the input data. In some examples, the system may identify the non-essential conversation data based on a policy. A policy may indicate which conversational data should not be considered by the LLM in generating its output. That is, companies, admins, users, etc. may modify and/or dictate what constitutes conversational data that “non-essential” and therefore not to be considered by the LLM. As such, the companies, admins, and/or users may set or otherwise determine the policy. In the case of a company (or organization), the policy may apply to some or all users requesting data that was input by the company and/or any data relevant to the company. As such, if an employee of a company requests that the system performs an operation, the system may retrieve the policy that was set by the employee's company. For example, an administrator of the system (e.g., an administrator of a CRM system) may consider multiple different types of conversation data as “non-essential” based on the type of operation the system is to perform. That is, if the request is to extract customer contact reasons from conversation data associated with existing channel types, then the system may generate a previous or otherwise known instruction corresponding to “known” non-essential data. Alternatively, if the request is to extract customer contact reasons from data associated with a new channel type, then the system may generate a corresponding new instruction.

At operation 406, the process 400 can include generating, in response to identifying the non-essential conversation data, input data that includes an instruction to ignore the non-essential conversation data. Based on receiving the request, the system may prepare (or generate) data to input (e.g., input data) into the LLM. That is, the system may generate input data that contains the information needed by the LLM to perform the requested operation(s). As such, the system may receive and/or retrieve a common conversation object upon which the LLM is to act. A common conversation object may be a predefined organization of the data to be input to the LLM. As discussed above, in some examples a common conversation object may include non-essential conversation data. Accordingly, the system may further generate an instruction delineating that the LLM should not consider the non-essential conversation data included in the common conversation when generating its output. Further, at operation 406, the process 400 can include generating the input data based on the policy and the data (e.g., the common conversation object). Moreover, at operation 406, the process 400 can include generating a constraint on the output of the LLM. In at least one example, the process 400 can include generating a maximum length constraint on the LLM output.

At operation 408, the process 400 can include inputting the input data into the generative machine learned model that is configured to output a response(s) based on the input data and the instruction. That is, based on generating the input data, the system may input the input data to the LLM. As noted above, the system may include one or more generative machine learned models (e.g., LLMs) that may be trained to perform various system operations. In some cases, the system may train the LLMs to perform specific tasks. Accordingly, the system may input the input data into the LLM.

At operation 410, the process 400 can include receiving, from the generative machine learned model, the response(s). In some examples, the LLM may be trained to generate output data. Thus, the system may receive, from the LLM, output data (or a response). The output data (or response) may be a document, summary, recommendation, etc. In some examples, the system may cause the output data (or the response) to be output to the requesting user. The system may output the output data via displaying the output data on a user interface of a user device and/or causing a device to emit the output data via audio. That is, if the user requested the action via a user interface of a user device, the system may cause the output data to be displayed via the user interface. Further, if the user requested the action via speaking to a device, the system may cause the output to be emitted via audio. However, this is not intended to be limiting; in other examples, the system may emit the output via audio in response to the user requesting the action via a user interface and/or the system may cause the output data to be displayed via user interface in response to the user verbally requesting the action.

At operation 412, the process 400 can include generating embeddings based on the response(s). In some examples, the generated embeddings can include sentence embeddings. As such, at operation 412, the system may generate and associate embeddings with each sentence comprising the response generated by the LLM. In this way, similar sentences may be assigned similar embeddings (or vectors) whereas different sentences may be assigned different embeddings.

At operation 414, the process 400 can include determining whether an extracted contact reason (e.g., the response generated by and received from the generative machine learned model at operation 410) occurs only in association with a single channel. That is, at operation 414, the process 400 can include determining whether an extracted contact reason is inherently channel-specific. As discussed above, the system may generate embeddings based on the response received at operation 410 to this end. As such, if there exists an embedding to which the contact reason can be coherently associated (414:No), then the system may group or “cluster” the extracted contact reason with other similar contact reasons at operation 416. In contrast, if there does not exist an embedding to which the contact reason can be coherently associated (414:Yes), then the system may generate at operation 418 a channel-specific cluster (e.g., name, topic, etc. ,) to represent the extracted contact reason.

In some examples, one or more of operation 416 can include generating a name, title, topic, or the like associated with the cluster of similar contact reasons. For instance, the operation 416 can include considering (e.g., by the CRM system or a component thereof) only contact reasons belonging to a cluster when generating the cluster name. In at least one example, the operation 416 can include sampling (such as by using top-k log likelihood or the like) the top k contact reasons in a cluster according to their similarity as potential “candidates” for the cluster name. In such circumstances, k is an integer that can be determined according to any relevant constraints. For instance, the CRM system of examples may determine one or more k values to enforce channel diversity in circumstances where contact reasons in a given cluster represent disproportionate channel volume (e.g., 10% of contact reasons are extracted from a voice communication channel, 20% from a messaging communication channel, and 70% from an email communication channel). The CRM system may, in such an example, stratify k by channel proportion. That is, given a constraint that the CRM system (e.g., the LLM) may consider only the top k contact reasons according to similarity (where k equals 50), the CRM system may sample the top 5, 10, and 35 most similar contact reasons from each of voice, messaging, and email communication channels, respectively. The CRM system may hydrate an LLM prompt that instructs the LLM to generate a “name” for the cluster with the top k contact reasons (e.g., as a grounding source).

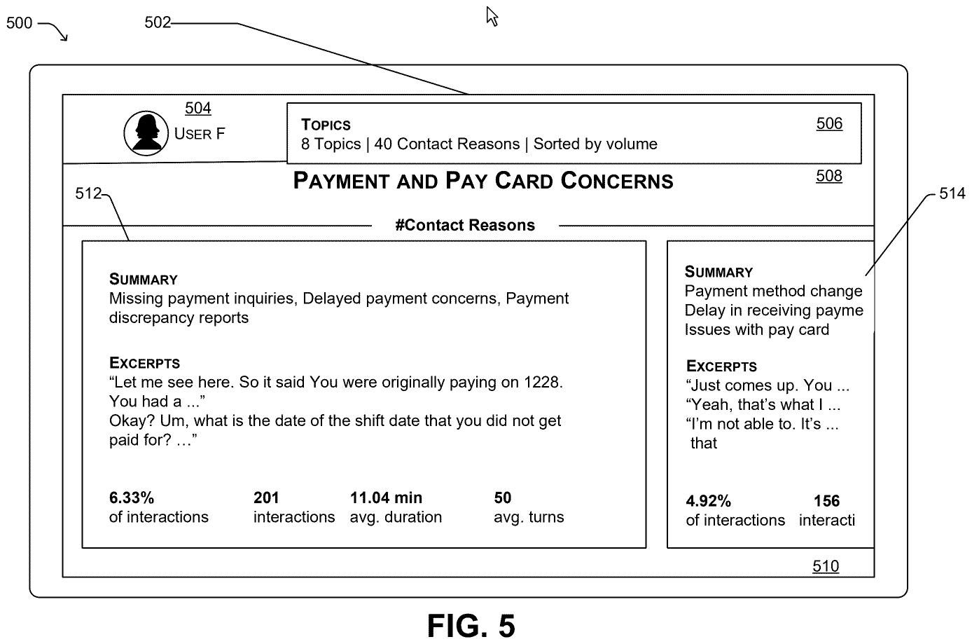

FIG. 5 illustrates an example user interface 500 (also referred to herein as a “dashboard”) associated with a CRM environment as described herein, and comprising a data feed 502. For instance, the data feed 502 may include and/or be based on LLM responses and/or subsets of those responses, which are generated and clustered according to similarity as disclosed herein. For instance, as discussed throughout, a requesting user of an example CRM system may request that the CRM system extract one or more customer contact reasons from conversation data. Thus, the example dashboard 500 of FIG. 5 may allow the user to monitor metrics relating to the CRM environment including, but not limited to, the extracted customer contact reasons. As such, the example user dashboard 500 may allow the requesting user to visualize key data in order to identify trends, sort out quantities, measure the impact of ongoing activities as well as performing other tasks based on insight provided by the data.

In some examples, the data feed 502 can include a first region 504, or subsection, that includes indicator(s) (e.g., user interface element(s), affordance(s), object(s), etc.) representing the requesting user (User F) with which the data feed 502 is associated. For instance, the requesting user (User F) may be a customer service manager who leverages the data feed 402. Thus, the first region 510 may represent environments, spaces, organizations, or the like having data that the requesting user (User F) is permitted to access.

In some examples, data can be organized and/or is sortable. For instance, the data feed 502 may be organized and/or sortable according to a hierarchical organizational scheme. In this way, the data feed 502 may organize data according to varying granularities as needed. Accordingly, the data feed 502 can include a second region 506, or subsection, that includes indicator(s) (e.g., user interface element(s), affordance(s), object(s), etc.) representing a first level or organization of the data in the data feed 502. That is, the second region 506 may provide a high-level overview or summary of the data feed 502. In the illustrated example, the high-level overview provided by the second region 506 summarizes the data feed 502 according to three criteria: (1) number of topics contained in the data feed, (2) number distinct contact reasons contained in the data feed, and (3) how the contact reasons are sorted or displayed. In particular, the second region 506 provides a quick visual summary for the requesting user (User F) that there are 8 topics represented in the data feed. The eight topics are based on forty distinct contact reasons. Further, the topics/contact reasons are presented in the data feed according to volume (e.g., the most frequently occurring topics/contact reasons are presented first in the data feed 502 or similar presentation schemes based on volume). Though, it will be appreciated that any other computed metric (e.g., duration and/or conversation length, complexity of issue involved, etc.) may be used to organize the data feed.

In some examples, the data feed 502 can include a third region 508, or subsection, that includes indicator(s) (e.g., user interface element(s), affordance(s), object(s), etc.) representing a second level or organization of the data in the data feed 502. That is, the third region 508 may provide more granular or specific data as compared to the second region 506. In at least one example, the third region 508 can be associated with data indicating a currently viewed topic. In the illustrated example, the requesting user (User F) is viewing data related to the topic “payment and pay card concerns” as indicated by the third region 508. Although not illustrated, in some examples the third region 508 can further include indicator(s) associated with comparative statistics relating to the currently viewed topic. For instance, the third region 508 can indicate that the topic “payment and pay card concerns” accounts for 20.36% of user interactions within the user's CRM environment. Other statistics may include average duration of related interactions, average number of turns in related conversations, total number of related interactions, and the like are also contemplated. In some examples, the second region 506 can include a user interface element, affordance, or the like that is configured to reveal the third region 508 based on a user interaction therewith. Accordingly, in some examples, the CRM system can cause the third region 508 to be presented to the requesting user (User F) in response to a determination that the user interface element or affordance associated with the second region 506 was triggered.

As illustrated, the data feed 502 is further organized by customer contact reason (e.g., #contact reasons). As such, one or more indicators associated with various customer contact reasons determined by the CRM to represent the currently viewed topic (e.g., “payment and pay card concerns) can be presented in a third region 510, or subsection. In at least one example, the one or more indicators can provide analytics (e.g., real-time analytics) related to customer contact reasons including, but not limited to, a summary of customer contact reasons in a “group,” and pertinent excerpts and statistics from the underlying conversation data. As shown, the third region 510 includes a first indicator 512 associated with customer contact reasons summarized as including “missing payment inquiries, delayed payment concerns, payment discrepancy reports.” The third region is also shown to include a second indicator 514 (partially obscured) associated with customer contact reasons summarized as including “payment method change inquiries, delay in receiving payments, issues with pay card.” Because the illustrated data feed 502 is organized by customer contact reason (e.g., customer contact reasons representing “payment and pay card concerns”), both indicator 512 and indicator 514 are presented together. However, while only two indicators 512 and 514 are shown, it is to be understood that any appropriate number of indicators may be presented in order to allow the requesting user (User F) to accurately assess the underlying conversation data.

### Example Clauses

A: A method comprising; receiving, from a user profile of a user, a request for a generative machine learned model to perform an action based at least in part on conversation data; generating, in response to identifying non-essential conversation data based at least in part on a communication channel from which the conversation data was received, an instruction for the generative machine learned model to disregard the non-essential conversation data; inputting the conversation data and the instruction into the generative machine learned model that is configured to output a response; receiving, from the generative machine learned model, the response; generating, based at least in part on the response, one or more embeddings; determining, based at least in part on the one or more embeddings, to group a first subset of the response with a second subset of the response as a similar group; and causing the response and the similar group to be output to the user profile.
B: The method of paragraph A, wherein: the first subset of the response is a first sentence summarizing a first conversation; the second subset of the response is a second sentence summarizing a second conversation; and generating the one or more embeddings comprises generating a first sentence embedding associated with the first sentence and a second sentence embedding associated with the second sentence.
C: The method of paragraph B, wherein the request is a request to extract one or more customer contact reasons from the conversation data, and wherein the first sentence represents a first customer contact reason and the second sentence represents a second customer contact reason.
D: The method of paragraph A, wherein the non-essential conversation data includes greetings, salutations, pause words, repetitive utterances, automated messages, agent validation, and customer identity verification.
E: The method of paragraph A, wherein causing the response and the similar group to be output to the user profile comprises causing the response and the similar group to be presented via a user interface associated with the user profile.
F: The method of paragraph E, wherein the user interface is organized hierarchically and comprises at least a region indicating a statistical overview associated with the conversation data.
G: The method of paragraph A, wherein the request is a first request and further comprising: receiving, from the user profile of the user, a second request for the generative machine learned model to summarize the similar group.
H: An apparatus comprising at least one processor and at least one memory including computer program code, the at least one memory and the computer program code configured to, with the at least one processor, cause the apparatus to perform operations comprising; receiving, from a user profile of a user, a request for a generative machine learned model to perform an action based at least in part on conversation data; generating, in response to identifying non-essential conversation data based at least in part on a communication channel from which the conversation data was received, an instruction for the generative machine learned model to disregard the non-essential conversation data; inputting the conversation data and the instruction into the generative machine learned model that is configured to output a response; receiving, from the generative machine learned model, the response; generating, based at least in part on the response, one or more embeddings; determining, based at least in part on the one or more embeddings, to group a first subset of the response with a second subset of the response as a similar group; and causing the response and the similar group to be output to the user profile.
I: The method of paragraph H, wherein: the first subset of the response is a first sentence summarizing a first conversation; the second subset of the response is a second sentence summarizing a second conversation; and generating the one or more embeddings comprises generating a first sentence embedding associated with the first sentence and a second sentence embedding associated with the second sentence.
J: The method of paragraph I, wherein the request is a request to extract one or more customer contact reasons from the conversation data, and wherein the first sentence represents a first customer contact reason and the second sentence represents a second customer contact reason.
K: The method of paragraph H, wherein the non-essential conversation data includes greetings, salutations, pause words, repetitive utterances, automated messages, agent validation, and customer identity verification.
L: The method of paragraph H, wherein causing the response and the similar group to be output to the user profile comprises causing the response and the similar group to be presented via a user interface associated with the user profile.
M: The method of paragraph L, wherein the user interface is organized hierarchically and comprises at least a region indicating a statistical overview associated with the conversation data.
N: The method of paragraph H, wherein the request is a first request and further comprising: receiving, from the user profile of the user, a second request for the generative machine learned model to summarize the similar group.
O: A non-transitory computer-readable medium storing computer program code that, when executed by one or more processors, cause the one or more processors to perform operations comprising; receiving, from a user profile of a user, a request for a generative machine learned model to perform an action based at least in part on conversation data; generating, in response to identifying non-essential conversation data based at least in part on a communication channel from which the conversation data was received, an instruction for the generative machine learned model to disregard the non-essential conversation data; inputting the conversation data and the instruction into the generative machine learned model that is configured to output a response; receiving, from the generative machine learned model, the response; generating, based at least in part on the response, one or more embeddings; determining, based at least in part on the one or more embeddings, to group a first subset of the response with a second subset of the response as a similar group; and causing the response and the similar group to be output to the user profile.
P: The non-transitory computer-readable medium of paragraph O, wherein: the first subset of the response is a first sentence summarizing a first conversation; the second subset of the response is a second sentence summarizing a second conversation; and generating the one or more embeddings comprises generating a first sentence embedding associated with the first sentence and a second sentence embedding associated with the second sentence.
Q: The non-transitory computer-readable medium of paragraph P, wherein the request is a request to extract one or more customer contact reasons from the conversation data, and wherein the first sentence represents a first customer contact reason and the second sentence represents a second customer contact reason.
R: The non-transitory computer-readable medium of paragraph O, wherein the non-essential conversation data includes greetings, salutations, pause words, repetitive utterances, automated messages, agent validation, and customer identity verification, and further wherein causing the response and the similar group to be output to the user profile comprises causing the response and the similar group to be presented via a user interface associated with the user profile.
S: The method of paragraph R, wherein the user interface is organized hierarchically and comprises at least a region indicating a statistical overview associated with the conversation data.
T: The method of paragraph O, wherein the request is a first request and further comprising: receiving, from the user profile of the user, a second request for the generative machine learned model to summarize the similar group.

### CONCLUSION

Although the discussion above sets forth example implementations of the described techniques, other architectures may be used to implement the described functionality and are intended to be within the scope of this disclosure. Furthermore, although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

The various techniques described herein may be implemented in the context of computer-executable instructions or software, such as program modules, that are stored in computer-readable storage and executed by the processor(s) of one or more computing devices such as those illustrated in the figures. Generally, program modules include routines, programs, objects, components, data structures, etc., and define operating logic for performing particular tasks or implement particular abstract data types.

Other architectures may be used to implement the described functionality and are intended to be within the scope of this disclosure. Furthermore, although specific distributions of responsibilities are defined above for purposes of discussion, the various functions and responsibilities might be distributed and divided in different ways, depending on circumstances.

Similarly, software may be stored and distributed in various ways and using different means, and the particular software storage and execution configurations described above may be varied in many different ways. Thus, software implementing the techniques described above may be distributed on various types of computer-readable media, not limited to the forms of memory that are specifically described.

It should be appreciated that the term “subset” describes a proper subset. A proper subset of set is portion of the set that is not equal to the set. For example, if elements A, B, and C belong to a first set, a subset including elements A and B is a proper subset of the first set. However, a subset including elements A, B, and C is not a proper subset of the first set.

What is claimed is:

1. A method comprising:
receiving, from a user profile of a user, a request for a generative machine learned model to perform an action based at least in part on conversation data;
generating, in response to identifying non-essential conversation data based at least in part on a communication channel from which the conversation data was received, an instruction for the generative machine learned model to disregard the non-essential conversation data;
inputting the conversation data and the instruction into the generative machine learned model that is configured to output a response;
receiving, from the generative machine learned model, the response;
generating, based at least in part on the response, one or more embeddings;
determining, based at least in part on the one or more embeddings, to group a first subset of the response with a second subset of the response as a similar group; and
causing the response and the similar group to be output to the user profile.

2. The method of claim 1, wherein:
the first subset of the response is a first sentence summarizing a first conversation;
the second subset of the response is a second sentence summarizing a second conversation; and
generating the one or more embeddings comprises generating a first sentence embedding associated with the first sentence and a second sentence embedding associated with the second sentence.

3. The method of claim 2, wherein the request is a request to extract one or more customer contact reasons from the conversation data, and wherein the first sentence represents a first customer contact reason and the second sentence represents a second customer contact reason.

4. The method of claim 1, wherein the non-essential conversation data includes greetings, salutations, pause words, repetitive utterances, automated messages, agent validation, and customer identity verification.

5. The method of claim 1, wherein causing the response and the similar group to be output to the user profile comprises causing the response and the similar group to be presented via a user interface associated with the user profile.

6. The method of claim 5, wherein the user interface is organized hierarchically and comprises at least a region indicating a statistical overview associated with the conversation data.

7. The method of claim 1, wherein the request is a first request and further comprising:
receiving, from the user profile of the user, a second request for the generative machine learned model to summarize the similar group.

8. An apparatus comprising at least one processor and at least one memory including computer program code, the at least one memory and the computer program code configured to, with the at least one processor, cause the apparatus to perform operations comprising:
receiving, from a user profile of a user, a request for a generative machine learned model to perform an action based at least in part on conversation data;
generating, in response to identifying non-essential conversation data based at least in part on a communication channel from which the conversation data was received, an instruction for the generative machine learned model to disregard the non-essential conversation data;
inputting the conversation data and the instruction into the generative machine learned model that is configured to output a response;
receiving, from the generative machine learned model, the response;
generating, based at least in part on the response, one or more embeddings;
determining, based at least in part on the one or more embeddings, to group a first subset of the response with a second subset of the response as a similar group; and
causing the response and the similar group to be output to the user profile.

9. The apparatus of claim 8, wherein:
the first subset of the response is a first sentence summarizing a first conversation;
the second subset of the response is a second sentence summarizing a second conversation; and
generating the one or more embeddings comprises generating a first sentence embedding associated with the first sentence and a second sentence embedding associated with the second sentence.

10. The apparatus of claim 9, wherein the request is a request to extract one or more customer contact reasons from the conversation data, and wherein the first sentence represents a first customer contact reason and the second sentence represents a second customer contact reason.

11. The apparatus of claim 8, wherein the non-essential conversation data includes greetings, salutations, pause words, repetitive utterances, automated messages, agent validation, and customer identity verification.

12. The apparatus of claim 8, wherein causing the response and the similar group to be output to the user profile comprises causing the response and the similar group to be presented via a user interface associated with the user profile.

13. The apparatus of claim 12, wherein the user interface is organized hierarchically and comprises at least a region indicating a statistical overview associated with the conversation data.

14. The apparatus of claim 8, wherein the request is a first request and further comprising:
receiving, from the user profile of the user, a second request for the generative machine learned model to summarize the similar group.

15. A non-transitory computer-readable medium storing computer program code that, when executed by one or more processors, cause the one or more processors to perform operations comprising:
receiving, from a user profile of a user, a request for a generative machine learned model to perform an action based at least in part on conversation data;
generating, in response to identifying non-essential conversation data based at least in part on a communication channel from which the conversation data was received, an instruction for the generative machine learned model to disregard the non-essential conversation data;
inputting the conversation data and the instruction into the generative machine learned model that is configured to output a response;
receiving, from the generative machine learned model, the response;
generating, based at least in part on the response, one or more embeddings;
determining, based at least in part on the one or more embeddings, to group a first subset of the response with a second subset of the response as a similar group; and
causing the response and the similar group to be output to the user profile.

16. The non-transitory computer-readable medium of claim 15, wherein:
the first subset of the response is a first sentence summarizing a first conversation;
the second subset of the response is a second sentence summarizing a second conversation; and
generating the one or more embeddings comprises generating a first sentence embedding associated with the first sentence and a second sentence embedding associated with the second sentence.

17. The non-transitory computer-readable medium of claim 16, wherein the request is a request to extract one or more customer contact reasons from the conversation data, and wherein the first sentence represents a first customer contact reason and the second sentence represents a second customer contact reason.

18. The non-transitory computer-readable medium of claim 15, wherein the non-essential conversation data includes greetings, salutations, pause words, repetitive utterances, automated messages, agent validation, and customer identity verification, and further
wherein causing the response and the similar group to be output to the user profile comprises causing the response and the similar group to be presented via a user interface associated with the user profile.

19. The non-transitory computer-readable medium of claim 18, wherein the user interface is organized hierarchically and comprises at least a region indicating a statistical overview associated with the conversation data.

20. The non-transitory computer-readable medium of claim 15, wherein the request is a first request and further comprising:
receiving, from the user profile of the user, a second request for the generative machine learned model to summarize the similar group.
